(19) United States
(12) Patent Application Publication
(10) Pub. No.: US 2019/0139025 A1
(43) Pub. Date: May 9, 2019

(54) SECURING A SOCIAL ENGAGEMENT VIA A SHARED TRANSACTION

(71) Applicant: Other Half, LLC, Salt Lake City, UT (US)

(72) Inventor: Brigham Edward Jackson, Salt Lake City, UT (US)

(21) Appl. No.: 16/239,826

(22) Filed: Jan. 4, 2019

Related U.S. Application Data
(63) Continuation-in-part of application No. 15/932,436, filed on Dec. 21, 2016.

(51) Int. Cl. G06Q 20/32; G06Q 20/36; H04W 4/021

(52) U.S. Cl. CPC G06Q 20/3224; H04W 4/021; G06Q 20/3226; G06Q 20/3672

(57) ABSTRACT

A mobile application provides mutually selected users with half of a coupon for use at a public location, such as a local restaurant. The application on each user's mobile device then enables the coupon for use at the public location only when the mutually selected users are in the location, and near each other. Once the coupon is enabled, the users can present the coupon at the location, obtain a discount, and participate in the agreed activities.

### CROSS-REFERENCE TO RELATED APPLICATIONS

This application is a Continuation in Part of U.S. patent application Ser. No. 15/932,436 filed on Dec. 21, 2016 and entitled “SECURING A SOCIAL ENGAGEMENT VIA A SHARED TRANSACTION,” and which application is expressly incorporated herein by reference in its entirety.

### BACKGROUND OF THE INVENTION

As the Internet and the accompanying Internet commerce have expanded, user and application creators employ internet functionality increasingly to social introduction applications. Of recent popularity are applications related to enabling users who have never met before, but who share common interests, an avenue to meet up. Dating applications are such an example.

Unfortunately, common dating or other form of social introduction applications suffer from a number of difficulties that ultimately limit the numbers and/or types of users that would use such applications. Current social meeting applications (e.g., “dating apps”) enable users to select each other based entirely on online profiles and pictures that are easily spoofed. Moreover, when the users agree to meet up after some initial communications with each other, the users must select the locations and times for meeting essentially at random. The ease of spoofing profiles, pictures, and interests can make it difficult for users keeping these issues in mind to agree to meet. Moreover, if the users are not careful about the time and location of meeting up, there is great potential for physical and other types of harm or abuse, especially if the users meet for the first time in a private, unsecured location, or in a location controlled by one but not both users. Not surprisingly, people often view dating apps primarily as a sexual link-up tool rather than as an application that can be useful for initiating and developing long term, meaningful relationships.

In addition, social dating in general tends to require money and other resources that some users (particularly younger users, such as college-aged users) may find less accessible. Thus, although dating apps tend to be capable at introducing people and helping people select a match based on a wide variety of personal criteria, the negative associations of such applications coupled with the real costs of dating can turn off a number of users. Some of these users might otherwise be interested in meeting new people, or might even be less socially inclined, but might find value in online tools that make social introductions easier and more secure.

Accordingly, there is a need for technological tools that ease initial introductions within a dating or friendship meeting. The technological tools may be required to intelligently match individuals, intelligently establish a meet-up location, dynamically handle the costs associated with the meeting, and various other similar actions. Additionally, dynamically handling costs associated with the meeting may require the use of a novel joint transaction authorization system that allows two strangers to mutually authorize various financial aspects of the meeting. Further, after reviewing the disclosure provided herein, one will appreciate that there are many technological aspects disclosed herein that extend well beyond conventional organization of human activity.

Accordingly, there are a number of problems in the art of social introduction applications and joint transaction authorization systems that can be addressed.

### BRIEF SUMMARY OF THE INVENTION

Implementations of the present invention comprise systems, methods, and apparati configured to authorize computing transactions by verifying that at least two discrete computing devices are simultaneously meeting one or more authorization parameters required by the transaction, for example a physical location requirement. In at least one implementation, for example, users of a mobile application operating at different mobile computing devices (mobile devices) identify each other using online profiles, and then select each other for introduction. The mobile application then independently authorizes each of the mobile devices with half of a transaction element that enables a transaction at a public location, such as a local restaurant.

In one embodiment of the present invention, a joint transaction between two computing systems is enabled. Notably, the transaction includes receiving a request to initiate a joint transaction from a first mobile device that is associated with a first user. Based upon receiving the request, one or more authorization parameters associated with the joint transaction are identified. A first token is generated and transmitted to the first mobile computing system. A notification is also transmitted to a second mobile device. Notably, this notification includes at least an indication, presented at a user interface of the second mobile computing device, that may include the one or more authorization parameters associated with the joint transaction, the identity of the first user, and a second token. An indication is received from both of the first mobile computing system and the second mobile computing system that includes one physical parameter of the respective mobile computing system and the token previously transmitted to the respective mobile computing system. Based on the received indications and the first token and the second token, it is determined that the first mobile computing systems and the second mobile computing system have simultaneously satisfied the one or more authorization parameters. A transaction element is then activated, and the transaction element is transmitted to at least one of the first mobile computing system or the second mobile computing system.

In another embodiment of the present invention, a request to initiate a multi-entity transaction is received from a first mobile device associated with a first registered. Based upon receiving the request, one or more authorization parameters associated with the joint transaction are identified and a first token is generated and transmitted to the first mobile device. A notification is then transmitted to a second mobile device and may include an indication, presented at a user interface of the second mobile device, of the the one or more authorization parameters associated with the joint transaction and the identity of the first user along with a second token. Indications are then received from both the first mobile device and the second mobile device. Notably, these indications include one physical parameter of the respective mobile device and the token previously transmitted to the respective mobile device. Based on the received indications and tokens, a determination is made that the first mobile device and the second mobile device are simultaneously satisfying the one or more authorization parameters. The joint transaction element is activated and transmitted either or both of the first mobile device or the second mobile device.

In another embodiment of the present invention, a dynamic joint transaction between two computing systems is enabled. The transaction includes receiving a request to initiate a joint transaction from a first mobile device associated with a first user. Based upon receiving the request, one or more authorization parameters associated with the joint transaction are identified including one or more of authorization parameters that require an additional mobile device be identified. The first mobile device is caused to wirelessly transmit an identifier within a defined local area that uniquely identifies the first mobile device at the remote system. A request to join the joint transaction is received from a second mobile device. The request to join including at least the identifier wirelessly transmitted by the first mobile device. It is then determined that the request to join the joint transaction is authorized and a notification indicating that the joint transaction has been authorized and activated is caused to be generated on either or both of the first mobile device or the second mobile device.

The application on each user's mobile device enables the transaction element to be used at the public location only when the mobile devices for each selected user meet one or more predetermined authorization criteria, such as a physical proximity threshold. Once the transaction element is enabled by both computing devices meeting the predetermined authorization criteria, the users of the mobile devices can utilize the transaction element for its intended purpose, for example to obtain a discount or participate in activities associated with the transaction element at the location associated with the predetermined authorization criteria.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

To describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a schematic of a mobile device showing an initial user profile for use in connection with an implementation of the present invention;

FIG. 2 illustrates a schematic of a chat dialog box that may be implemented through the application upon mutual selection of users in connection with an implementation of the present invention;

FIG. 3 illustrates an interface for a mobile application that provides a series of options where the users can agree to meet in connection with an implementation of the present invention;

FIG. 4 illustrates a schematic of a transaction element provided through a mobile application, but before the application enables the transaction in connection with an implementation of the present invention;

FIGS. 5A through 5C illustrates a flow in which two mobile devices activate a transaction element at a designated physical location in connection with an implementation of the present invention;

FIG. 6 illustrates a computer system that generates and transmits a transaction element to multiple computing devices based on satisfaction of predetermined authorization criteria, according to an implementation;

FIG. 7 illustrates a computer system configured to identify and facilitate the authorization of a joint transaction between a requesting computing system and a preferred second computing system, according to an implementation;

FIG. 8 is a flow diagram of an exemplary method for executing one implementation of the present invention; and

FIG. 9 is a diagram of a computing system that may be configured to execute one implementation of the present invention.

### DETAILED DESCRIPTION OF THE PREFERRED EMBODIMENTS

The present invention extends to systems, methods, and apparati configured to authorize computing transactions by verifying that at least two discrete computing devices are simultaneously meeting one or more authorization parameters required by the transaction, for example a physical location requirement. In at least one implementation, for example, users of a mobile application operating at different mobile computing devices (mobile devices) identify each other using online profiles, and then select each other for introduction. The mobile application then independently authorizes each of the mobile devices with half of a transaction element that enables a transaction at a public location, such as a local restaurant.

In one embodiment of the present invention, a joint transaction between two computing systems is enabled. Notably, the transaction includes receiving a request to initiate a joint transaction from a first mobile device that is associated with a first user. Based upon receiving the request, one or more authorization parameters associated with the joint transaction are identified. A first token is generated and transmitted to the first mobile computing system. A notification is also transmitted to a second mobile device. Notably, this notification includes at least an indication, presented at a user interface of the second mobile computing device, that may include the one or more authorization parameters associated with the joint transaction, the identity of the first user, and a second token. An indication is received from both of the first mobile computing system and the second mobile computing system that includes one physical parameter of the respective mobile computing system and the token previously transmitted to the respective mobile computing system. Based on the received indications and the first token and the second token, it is determined that the first mobile computing systems and the second mobile computing system have simultaneously satisfied the one or more authorization parameters. A transaction element is then activated, and the transaction element is transmitted to at least one of the first mobile computing system or the second mobile computing system.

In another embodiment of the present invention, a request to initiate a multi-entity transaction is received from a first mobile device associated with a first registered. Based upon receiving the request, one or more authorization parameters associated with the joint transaction are identified and a first token is generated and transmitted to the first mobile device. A notification is then transmitted to a second mobile device and may include an indication, presented at a user interface of the second mobile device, of the the one or more authorization parameters associated with the joint transaction and the identity of the first user along with a second token. Indications are then received from both the first mobile device and the second mobile device. Notably, these indications include one physical parameter of the respective mobile device and the token previously transmitted to the respective mobile device. Based on the received indications and tokens, a determination is made that the first mobile device and the second mobile device are simultaneously satisfying the one or more authorization parameters. The joint transaction element is activated and transmitted either or both of the first mobile device or the second mobile device.

In another embodiment of the present invention, a dynamic joint transaction between two computing systems is enabled. The transaction includes receiving a request to initiate a joint transaction from a first mobile device associated with a first user. Based upon receiving the request, one or more authorization parameters associated with the joint transaction are identified including one or more of authorization parameters that require an additional mobile device be identified. The first mobile device is caused to wirelessly transmit an identifier within a defined local area that uniquely identifies the first mobile device at the remote system. A request to join the joint transaction is received from a second mobile device. The request to join including at least the identifier wirelessly transmitted by the first mobile device. It is then determined that the request to join the joint transaction is authorized and a notification indicating that the joint transaction has been authorized and activated is caused to be generated on either or both of the first mobile device or the second mobile device.

The application on each user's mobile device enables the transaction element to be used at the public location only when the mobile devices for each selected user meet one or more predetermined authorization criteria, such as a physical proximity threshold. Once the transaction element is enabled by both computing devices meeting the predetermined authorization criteria, the users of the mobile devices can utilize the transaction element for its intended purpose, for example to obtain a discount or participate in activities associated with the transaction element at the location associated with the predetermined authorization criteria.

Existing transaction element authorization systems can be improved upon by enabling transaction authorization requirements that are linked to multiple different computing devices corresponding to multiple different users. For example, while it is known in the art to authorize computing transactions for an individual user based on authorization parameters (e.g., location, passwords, etc.), the ability to authorize a single, joint transaction, involving multiple computing systems is unknown.

It is also appreciated that the included implementations improve on existing technological systems associated with multi-party transactions. For example, the described improvements include the ability to limit access to a transaction element until certain criteria are simultaneously met at multiple computing systems that are each managed and controlled by unrelated parties. In addition, implementations described herein enable a shared transaction verification paradigm. For example, a centralized computer system is configured to establish and verify some portions of a multi-user transaction and is also configured to cause the separate devices themselves to establish and manage other portions of the verification process. In so doing, communications between each mobile device and the central system are reduced improving the efficiency of such systems.

Accordingly, one will appreciate in view of the present specification and claims that implementations of the invention enable users to receive a transaction element based on multiple associated users simultaneously satisfying at least one authorization requirement, such as physical location. It is appreciated that a “transaction element” may be one of a number of computer generated elements that are presented at a user device upon authorization of certain parameters associated with the transaction element. Depending on the implementation, the transaction element may take the form of a digital coupon, access code, token (e.g., an authentication token or transaction token), personalized instruction, unique identifier, or other means that allows a user to receive a tangible benefit by using the transaction element. Moreover, as understood more fully herein, implementations of the present invention further provide benefits to local businesses, who can see increased traffic from users who might not initially be inclined to participate in offerings due to cost issues.

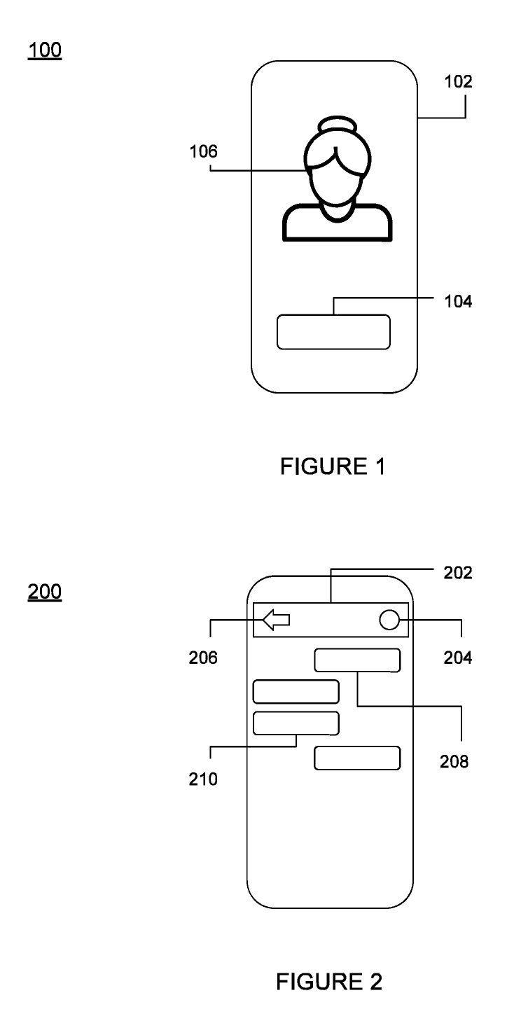

Referring now to the Figures, FIG. 1 illustrates a schematic of a mobile device 102 showing an initial user profile 106. In at least one implementation, a mobile application operating on mobile device 102 enables users to create the profile 106 that includes any number of pictures and other categories and descriptors. The mobile application also provides user interface elements, such as selector 104, that enable receiving inputs within the application. For example, utilizing selector 104, a user may provide a section input (e.g., a tap) or a gesture to (e.g., swipe right or left on items)

In one implementation, swiping right on selector 104 indicates that the user likes what is presented in profile 106, whereas swiping left equals disliking and avoiding profile 106. One will appreciate that the mobile application can be configured to select the users presented in any number of ways, such as by swiping up, left, right, down, or even by holding a finger on the screen for a determined time interval.

In at least one implementation, the mobile application does not introduce users to the next phase of the relationship unless the user corresponding to the selected profile 106 provides an affirmative response (e.g., a return “like”), or otherwise agrees through the application to meet the selecting user.

When there is a mutual like/selection from both users (i.e., the selecting user and the selected user), the mobile application assigns both users a transaction element, and can further enable other features. For example, FIG. 2 illustrates an interface 200 that includes chat dialog feature that the application provides after selection so that the users can further communicate. In addition, the mobile application can present users with a number of options for using a transaction element, selecting places to use the coupon, and so on.

For example, in one implementation, interface 200 includes a navigation area 202 that includes profile identifier 204 and navigation function 206. Interface 200 may be invoked when the mobile device 102 receives an input at selector 104 that is interpreted as meaning the user of mobile device 102 would like to engage with the user associated with profile 106.

It is appreciated that navigation function 206 include profile identifier 204 that includes some indication that is associated with the profile 106. For example, after the chat function is invoked, a small image of the user of profile 106 is included within profile identifier 204. Navigation function 206 may also provide additional functionality within interface 200, such as allowing the user of mobile device 102 to return to the interface of FIG. 1 to interact with a different user profile.

Within interface 200, the mobile application may provide a text or multi-content-based communication interface. In one implementation, interface 200 provides users with the ability to communicate using text. As illustrated, the conversation may be arranged to indicate which user is “speaking.” For example, element 208 is aligned to the right to indicate that it came from one user while element 210 is aligned on the left to indicate that it came from the other user. It is appreciated that in some implementations, alternative or additional user interface elements may be presented.

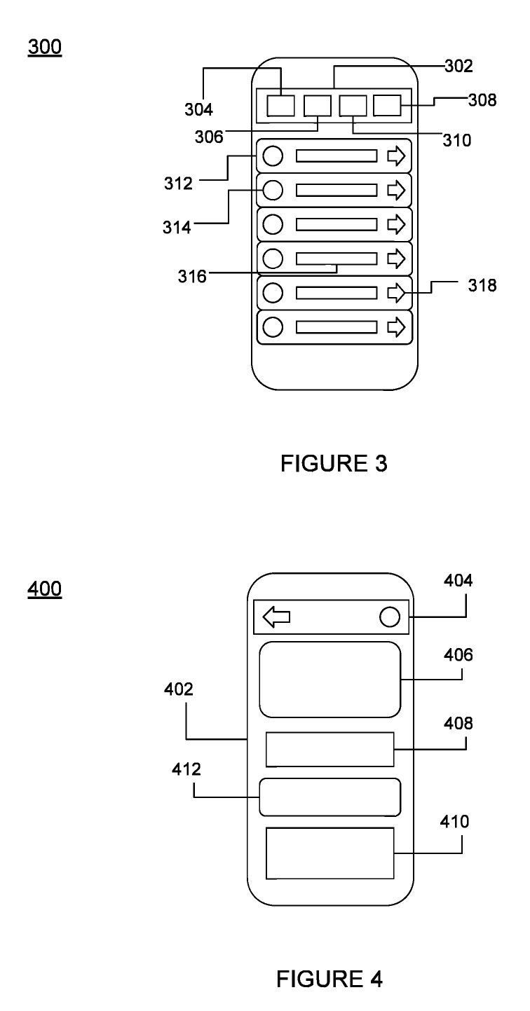

FIG. 3 illustrates a schematic 300 in which a mobile application provides a series of options associated with transaction elements for selection by application users. For example, the options may include public venues, such as restaurants, entertainment venues, service providers, or the like, that have offered transaction elements to users of the application.

In the illustrated case, FIG. 3 indicates multiple venues where the users can agree to meet and utilize the associated transaction element. For example, two users may mutually select item 312 that is associated with a particular venue at a particular location, the mobile application can then present one or both of the users with a set of options that can be used with the transaction element at the agreed location.

Included within the user interface 300 of FIG. 3 are numerous user interface elements that allow users to interact with a mobile application to obtain and utilize transaction elements. For example, the user interface of FIG. 3 includes a content area 302 that contains zones 304, 306, 308, and 310. It is noted, however, that content area 302 may be configured to have greater or fewer number of content zones.

In one exemplary implementation, the available content zones are occupied by a flow diagram of the steps a user of user interface 300 needs to take in order to obtain a validated, activated, transaction element. For example, the content zones may be utilized to visually display authorization parameters associated with a transaction element.

In one implementation, a transaction element may include four authorization requirements. These requirements are then shown in content area 302. For example, content area 304 may include an authorization parameter that shows that a user must match with another user to utilize the transaction element. Content area 306 may then include an authorization parameter indicating that the two matched users must then meet at a designated physical location to activate the transaction element. Content area 308 may then include an authorization parameter indicating that at least one of the users must activate and then save the transaction element to their mobile device. Finally, content area 310 may then indicate that at least one of the users must present the saved, activated, transaction element in order to obtain the benefit associated with the transaction element.

One will appreciate in view of the specification and claims that providing a mutually agreeable public location can provide a number of benefits. Firstly, this enables a relatively safe physical space for the users to meet. It is safe at least in part, in one implementation, because the local, public location is one where unrelated third parties are likely to be present (e.g., other guests of the restaurant), and is also a location monitored, cleaned, and generally maintained by operators that are less likely to have a relationship to the users. This means that the operators of the local, public location are also more likely to be believed by the users to be independently accountable to local authorities and to general public opinions than they will be to any particular user of the application.

In another implementation of the user interface 300, the mobile application only provides transaction elements provided by a single vendor for the users to select. For example, each of the elements analogous to element 312 may be a listing for a different transaction element being offered. A user may then scroll through the list of available transaction elements (e.g., from one available transaction element to many available transaction elements).

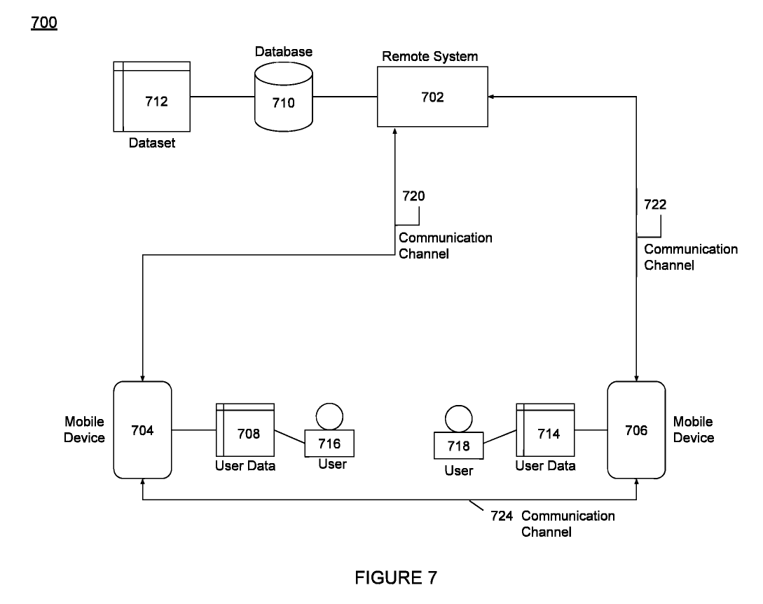

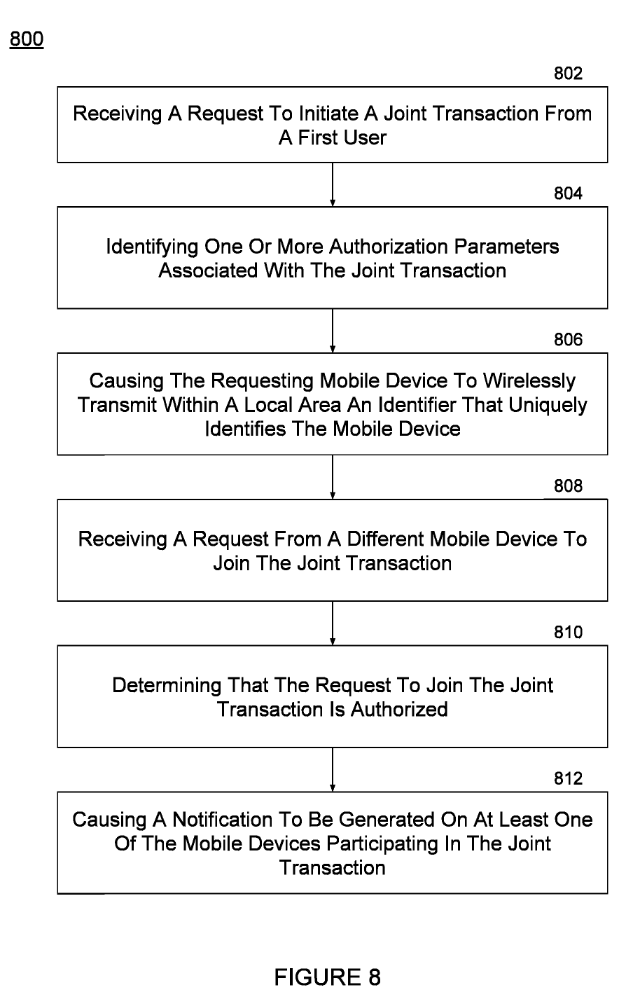

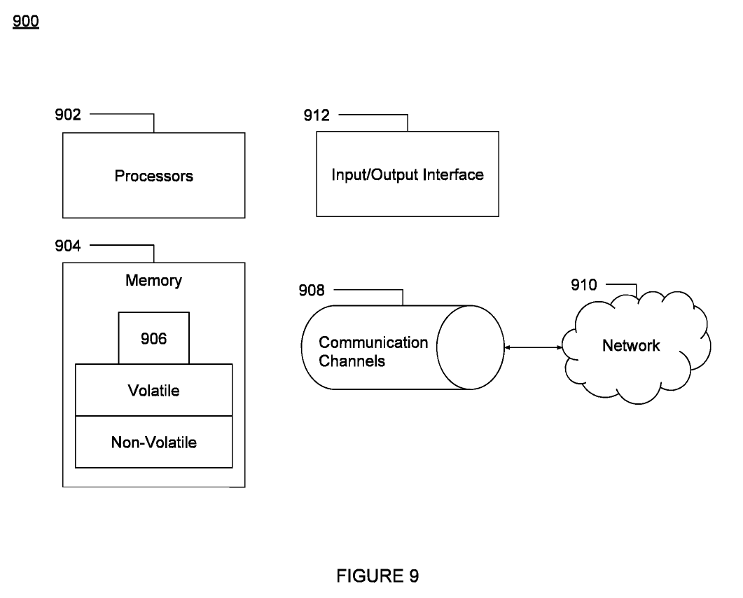

In another implementation, the transaction elements presented in user interface 300 may be pre-filtered based on one or more criteria. For example, in one implementation, only transaction elements that are available within a certain number of miles of the user's current location are presented. In another implementation, user preferences may be utilized in order to limit the number of types of transaction elements that are presented. For example, as will be discussed later in conjunction with FIGS. 7 and 8, a user may utilize the mobile application to create one or more user preferences that define the types of transaction elements they are interested in, the preferences for the types of users they would like to be matched to, their location, and other criteria.

Regardless of the type or source of the transaction elements presented to a user in user interface 300, transaction elements that require at least two users (e.g., joint transaction elements or mutli-user transaction elements), still require both users to select the option in order to agree to complete the meeting and activate the transaction element.

Specifically, once the users exchange mutual selections, the mobile application assigns the transaction element, or more specifically “half” of a transaction element to each user. In at least one implementation, the mobile application provides a time out feature so that the transaction element is only valid for a set period of time, but the users have only half of the discount. The application, in turn, only enables the transaction element once the mutually selected users are deemed to be close together and in the agreed location.

In one implementation, the half transaction element includes one-half of an encryption or authorization key that must be paired with a corresponding half transaction element to authorize or activate the complete transaction element. For example, a first user may request access to a joint transaction. In response, the user may receive, via the mobile application, a half-authorization key of “ABCDE.” Upon matching with another user to co-use the transaction element, the other user may receive a half-authorization key of “12345.” In such an implementation, neither half-authorization key is able to be used, alone, to obtain the benefit of the transaction element. Rather, only by combining the two half-authorizations are the user able to benefit. For example, by presenting a transaction element service provider with a combined authorization key of “ABCDE12345.”

In some implementations, such half-authorization keys may be augmented by additional dynamic information. For example, in addition to two users presenting their halves of an authorization key, a particular transaction element might also require that the two halves are presented while the two computer systems that received the keys are also simultaneously present in the same physical location. Specifically, a transaction element may require both a presented portion, and a systematic verification of a criteria such as the location of a device that is associated with the half-authentication key.

Thus, it is appreciated, that in some embodiments, when a half-authorization is generated for a user participating in a joint or multi-user transaction, a record may be generated that links a mobile device with the half-authorization element. Specifically, the half-authorization may be recorded at a remote computing location (e.g., a cloud-based database), that associates the half-authorization with a unique identifier representing the associated mobile device (e.g., a user name corresponding to a user account corresponding to the mobile application installed on a user's mobile device.) In this way, the half-authorization can be verified as being associated with the same user that accepted the invitation to join the transaction (or initiated the transaction).

It is appreciated that this check reduces the likelihood that a user could spoof the other computing system and present both half-authorizations, circumventing the authorization parameters of a transaction element. It is also appreciated that his check helps both parties to the transaction have confidence that who they were expecting to share the transaction element with is who they will be required to share it with.

In at least one implementation, the application identifies the location of each user through wireless transmission protocols understood within the art such as, for example, GPS, WIFI, BLUETOOTH, or other appropriate location mechanisms implemented through the respective user's mobile device to determine that both users are in the agreed location, and within a particular distance of each other.

For example, in one implementation, the application does not enable the transaction element if the users meet at a location other than the agreed location. In another implementation, the application does not enable the transaction element until the users are within a predetermined physical range of each other, for example 1-3 feet, in order to enable better determinations of the agreed users in more public, crowded spaces. In still another implementation, the application provides an alert to one or both of the user's mobile devices when the agreed users are close enough together.

In one implementation, the mobile devices participating in the transaction are configured to utilize different capabilities built into the respective devices to establish both the absolute physical location as well as a relative location to the other mobile device. For example, in one implementation, the mobile devices are configured to utilize global positioning system (GPS) capable hardware within the mobile device to determine the physical location of the device. This information may then be shared with a remote computing system that is configured to facilitate the authorization of the transaction element. For example, the transaction element may include an authorization parameter that requires each mobile device to be within a predefined geofence (e.g., within the physical the confines of a restaurant as defined by a GPS-based physical boundary.)

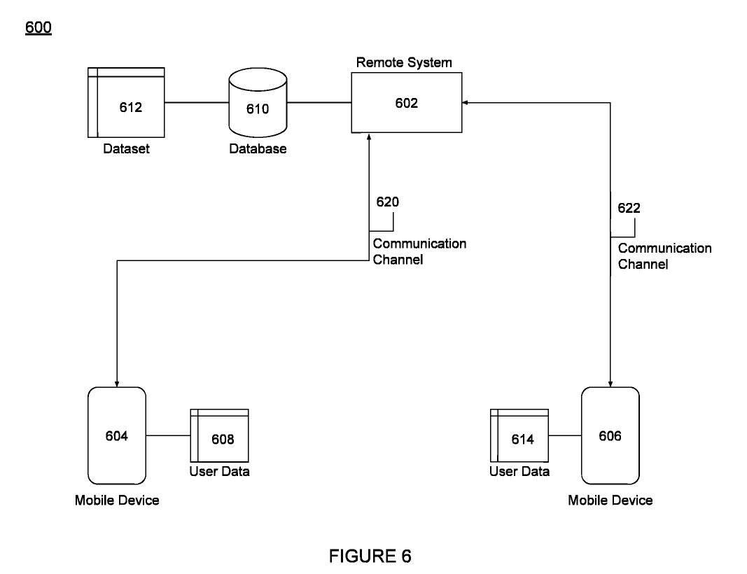

The mobile devices may then utilize a different wireless transmission capability, for example BLUETOOTH, to communicate with each other to establish or confirm the relative proximity of each mobile device to the other. For example, one mobile device may transmit a BLUETOOTH beacon that includes a unique identifier within a local transmission area, as defined and limited in range by a BLUETOOTH transmission protocol (e.g., Bluetooth version 4.2.) The other mobile device participating in the joint transaction may then be configured to receive such BLUETOOTH beacons and, upon receipt, generate a reciprocal transmission. In some implementations, the second mobile device may only receive the beacon. However, in either case, one or both of the mobile devices are configured to report a confirmation of proximity back to the remote management system (for example, remote system 602 of FIG. 6) to confirm that the two devices are within a certain proximity. It is also appreciated that one having ordinary skill in the art recognizes that protocols may be utilized to establish such a relative positioning. FIG. 4 illustrates a schematic of a transaction element provided through the mobile application, but before the application enables the transaction element in connection with an implementation of the present invention. As illustrated, element 406 may include a “Redeem” portion that is not selectable at the mobile devices until one or more criteria required for activation have not been met, as described above.

Once the criteria have been met, however, the element 406 changes appearance (e.g., becomes bolded, changes color, becomes selectable, etc.), and the users can select the element to redeem the transaction element. In at least one implementation, this includes the respective mobile applications for each corresponding user sending a signal to an application server hosting the applications (e.g., remote management system 602) that all criteria have been met for activation of the transaction element.

The application server then sends a response signal to each user's respective mobile device (or alternatively just one of the mobile devices) with sufficient data enabling the transaction element to activate. One or both of the users can then select element 406, which then reveals one or more codes, for example element 412 (e.g., a barcode or QR code), to be verified by the service provider associated with the transaction element.

While user interface 400 shows separate elements 406 and 412, in some implementations, the mobile application may be configured to dissolve or remove element 406 to reveal a transaction element behind element 412. Thus, user interface 400 is intended to illustrate that the user may be presented with a changeable interface that includes various stages of the transaction including initial request, activation, and then use of the transaction element.

User interface 400 may additionally include elements 408 and 410 that include textual or graphical instructions or other information to aid the user of interface 400 in meeting the authorization parameters of the selected transaction element.

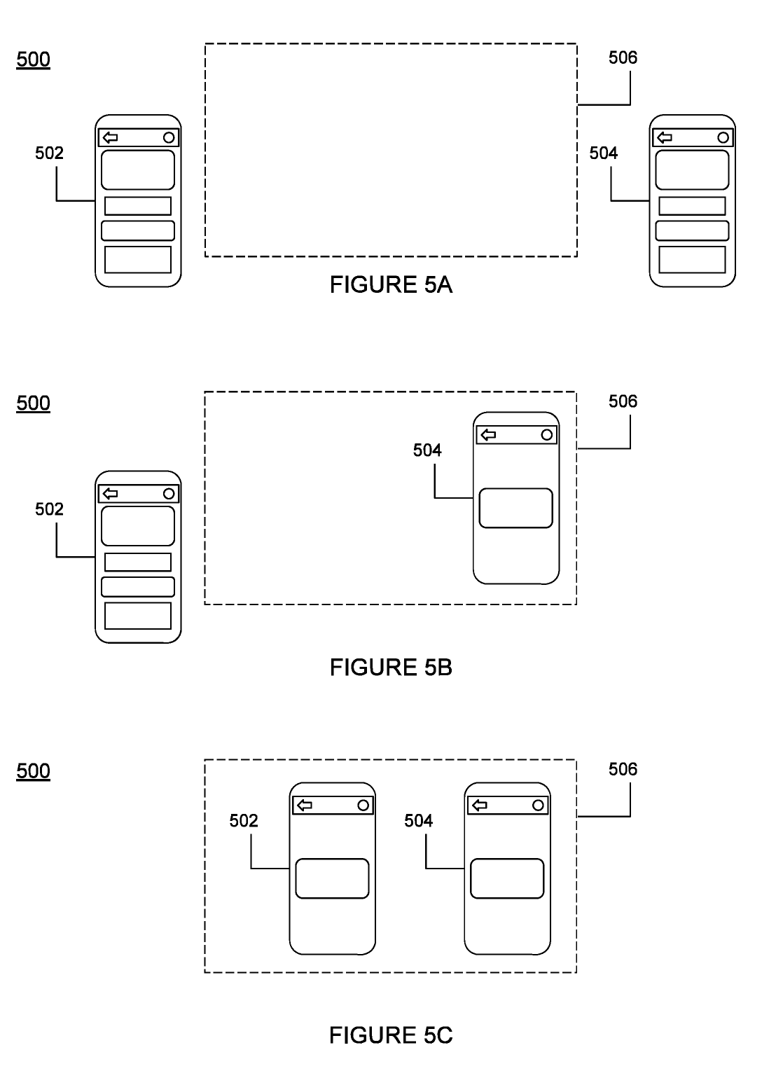

FIGS. 5A through 5C illustrate a flow of one implementation in which two users use an activated transaction element at a public location 506. Notably, public location 506 may be defined according to a geofence by registering, for example at remote management system 602, GPS coordinates corresponding to a boundary of public location 506.

In an initial step, illustrated in FIG. 5A, two users have agreed to meet, such as both by swiping right (e.g., FIG. 1) at an earlier point in time. As previously described, each of the users receive at their respective mobile application a transaction element or, as previously described, a half-authorization for a transaction element.

For example, the user of device 502 and the user of device 504 like each other in the mobile application and opt-in to participate in the same joint transaction. As a result, devices 502 and 504 are assigned half of a corresponding transaction element at their respective mobile applications. Notably, the users of devices 502 and 504 may receive their respective half-authorizations prior to meeting every authorization requirement of the transaction element (e.g., prior to being within the geofence defining public area 506.)

For example, the mobile app might enable a “buy one get one free combo meal at [x location]” transaction element (e.g., FIGS. 3 and 4), and cause each corresponding device to display this option (along with other information such as authorization parameters associated with the transaction element). As described, the mobile application provides each user half of the discount, so that the transaction element can only be activated once the authorization parameters associated with the transaction element are satisfied. In one implementation, each selected user requires the other half of the discount to be present to activate the transaction element.

In FIG. 5B, the user of mobile device 504 is now within public area 506 (as illustrated by mobile device 504 being shown within box 506.) In the presented implementation, upon satisfying the authorization parameter by being within public area 506, device 504 is updated to display a new interface as compared to the interface of device 504 in FIG. 5A. For example, once the authorization parameter has been met, device 504 may present a user with an indication that they have met the authorization parameter and that, once the other half-authorization is present, the transaction element will be authorized and activated for use.

It is also noted that device 502 has not been update because it has not entered public area 506 as required by the authorization parameter of the associated transaction element. However, it is appreciated that in some implementations, device 502 may receive a notification or other indication that other party sharing the joint transaction has met the authorization parameters. In this way, the user of device 502 may remain apprised of the status of the transaction.

FIG. 5C further shows, in a next step, both of the users' mobile devices are sufficiently close together (e.g., within public area 506) and thus the transaction element is authorized and activated. Accordingly, both devices 502 and 504 now include an updated user interface allowing the user to utilize the transaction element.

While the previous example relied on absolute positioning of devices 502 and 504 within a predefined geofence such as public location 506, other means are recognized for determining whether devices 502 and 504 have met physical location authorization parameters for a transaction element.

For example, each user's device may be configured to directly calculate the proximity of the other user's device through a unique device ID, or recognizes proximity through GPS, WIFI location, or Bluetooth location mechanisms. Upon detection of user proximity within the selected location, the application enables the respective halves of the transaction element together to create a full transaction element. The users can now present the barcode, transaction element, QR code, or other appropriate value to the operator of the public location.

As is also appreciated, in at least one implementation, the users of devices 502 and 504 present an activated transaction element (e.g., a barcode, QR code, authorization code, etc.) to a cashier who then reads the relevant transaction element code. In at least one implementation, the cashier can then validate the transaction element code. For example, the cashier can physically select the “Verify” button that shows up on one or both of the user's mobile devices.

In one implementation, upon utilization of the transaction element, a signal may be sent to the remote management server to indicate that the transaction element has been used and disabling that particular transaction element for future use. In another implementation, the cashier implements a point of sale device that digitally reads the code presented by the users and communicates with the application server to confirm the validity of the transaction element to the cashier, as well as to indicate at the application server that the transaction element has now been used.

In at least one implementation, a single use by the users at the location disables the transaction element from future use. In other cases, however, the location operator may implement the transaction element so that it has a specific number of uses so long as both of the users are present at the same time.

FIG. 6 illustrates, in at least one implementation, a joint transaction authorization system 600. System 600 includes remote computing system 602 that is attached to database 610 that includes dataset 612. One having ordinary skill in the art would recognize that database 610 can be configured according to any suitable means that allows data to be stored and retrieved from computing system 602. For example, as illustrated, database 610 includes a dataset 612. While computer system 602 is illustrated as connecting to a single database 610 including a single dataset 612, it is appreciated that in some implementations, multiple databases and datasets are contemplated.

Additionally, it is appreciated that the databases and datasets may be distributed data structures and may include logical as well as physical database and dataset configurations.

System 600 additionally includes communications channels 620 and 622 that allow remote system 602 to communicate with mobile device 604 and mobile device 606, respectively. The illustrated communications channels may be implemented in any suitable means. For example, mobile devices 604 and 606 may be configured to communicate with remote system 602 over the internet.

Mobile devices 604 and 606 respectively include datasets 608 and 614. It is appreciated that datasets 608 and 614 are contemplated to include any local data stored, accessed, or executed at the respective mobile device to enable the functionality described herein. For example, dataset 608 associated with mobile device 604 may include one or more applications installed on mobile device 604, one or more parameters configured at mobile device 604, and/or one or more sets of stored data.

In at least one implementation, dataset 608 includes a mobile application installed on mobile device 604 that is obtained through a remote app store, as understood in the art. Associated with the mobile application within dataset 608 are one or more user preferences or configuration parameters that are configured at mobile device 604 by a user of mobile device 604 or by default within the mobile application. For example, the user preferences or configuration parameters may include rules or preferences for dictating how a joint transaction should be configured when mobile device 604 makes a request to initiate the joint transaction.

In one implementation, dataset 608 includes information from other components or applications installed on mobile device 604. For example, dataset 608 may include contacts saved on device 604 corresponding to individuals that the user of device 604 knows. In one implementation, the mobile application installed on mobile device 604 is configured to utilize such contacts information to aid in making matches or connections within the mobile application.

In at least one implementation, these rules or preferences include preferences that relate to a user of another mobile device that should be included in the joint transaction. For example, parameters may include an age range, gender, common interest, physical proximity, or group identifier for the other user.

In the implementation illustrated in FIG. 6, the process of initiating a joint transaction begins when remote system 602 receives a request from mobile device 604 over communications channel 620.

In some implementations, the request received from mobile device 604 includes one or more request parameters. For example, the request may include requirements relating to one or more characteristics associated with another mobile device that will participate in the joint transaction such as the age range associated with the user of the other mobile device.

In some implementations, the request may include additional information such as the current location of mobile device 604, a user identifier associated with mobile device 604, or other necessary information about mobile device 604 (e.g., communication capabilities, notification preferences, etc.)

In response to receiving the initiation request, remote system 602 transmits a transaction token back to mobile device 604. This transaction token may include a unique identifier that correlates mobile device 604 to the current joint transaction request and that the transaction token may be used later to confirm that the requested joint transaction is authorized.

In some implementations, remote system 602 then operates to identify another mobile device to participate in the joint transaction. This process may include identifying another mobile device that is operating the same application included in dataset 608 and installed at mobile device 604. Thus, in some implementations, remote system 602 identifies another registered mobile device (and associated user) that has preinstalled a mobile application.

As described above, if the initial request received from mobile device 604 included required joint transaction parameters, remote system 602 may query database 610 to identify other mobile devices that have characteristics that meet the parameters required by the initiating device. This may be possible, for example, by collecting certain information about each mobile device when the mobile device installs the mobile application and creates an associated profile.

In the illustrated implementation, once another mobile device has been identified by remote system 602 as being qualifying to participate in the requested joint transaction, remote system 602 transmits a notification to the identified mobile device, for example mobile device 606. It is appreciated that more than one mobile device may be identified by remote system 602 as qualifying for participating in the requested joint transaction. In such situations, one or more rules may be available to remote system 602 to resolve the conflict.

For example, remote system 602 may be configured to select a mobile device that matches the greatest number of requirements, is physically closest to the requesting mobile device, or has previously engaged in a joint transaction (or has not engaged in a joint transaction) with the requesting mobile device. Alternatively, in some implementations, remote system 602 may be configured to transmit a notification to more than one qualifying mobile device.

Regardless of whether remote system 602 accesses rules or transmits a notification to multiple mobile devices, as illustrated in FIG. 6, a second mobile device 606 is caused to receive a notification. In some implementations, the indication includes one or more types of information.

For example, the notification may include one or more authorization parameters that mobile device 606 must meet to authorize the joint transaction. For example, mobile device 606 may be required to be in a physical location before the joint transaction is authorized. In some implementations, the notification also includes the identity associated with the requesting mobile device 604. For example, this may include information input into an installed mobile application by a user of mobile device 604 when registering an account. Notably, this identity information aids the user of mobile device 606 in determining whether they want to participate in the joint transaction by, for example, meeting the user of mobile device 604 at the physical location required by the authorization parameter.

In some implementations, the notification transmitted to mobile device 606 also includes a second transaction token. As with the transaction token transmitted to mobile device 604 in response to the request to initiate the joint transaction, mobile device 606 may also receive a token that correlates the device to the transaction such that remote system 602 can track and manage the devices that are part of the joint transaction. The token may also be configured to be utilized later (e.g., at joint transaction authorization), to ensure that the proper devices (e.g., parties), are participating in the transaction.

Remote system 602 then receives an indication from each of mobile device 604 and mobile device 606. This indication includes the respective tokens initially transmitted by remote system 602, as described above. Additionally, computer system 602 includes at least one physical parameter from the respective mobile device, for example the physical location of the mobile device.

Remote system 602 then determines, based on the received tokens and the received physical parameters, whether the anticipated participant devices are present, and whether the authorization parameters of the requested joint transaction have been met. For example, remote system 602 may compare the received tokens to a ledger, stored for example in database 610, of outgoing tokens that were recorded upon transmission to the mobile devices. Additionally, remote system 602 may be configured to analyze received location information, for example GPS data, from each mobile device to determine whether they are within geofence required by the authorization parameters of the joint transaction.

In the illustrated implementation, remote system 602 determines that the mobile devices are the correct devices (e.g., based on verifying the received tokens) and that they meet the authorization parameters of the joint transaction (e.g., are currently located in the correct physical location.) In response, remote system 602 activates a transaction element and transmits the transaction element to at least one of the mobile devices.

It is appreciated that the transaction element may come in numerous forms including, for example, a coupon, QR code, promo code, scannable image, dynamic link, or other similar data structure that is configured to allow the user of the respective mobile device to participate in a transaction at the physical location.

It is also appreciated that while the illustrated embodiment contemplates a scenario in which remote system 602 verifies that the transaction should be authorized, remote system 602 may also determine, in other scenarios, that the received data does not match either required party information and/or the authorization parameters required by the joint transaction. In such cases, remote system 602 may be configured to generate a notification to the mobile devices that includes an instruction or explanation as to why the joint transaction cannot be authorized.

It is also contemplated that, in some implementations, the operator of the second mobile device (e.g., mobile device 606) may not want to participate in the joint transaction. Accordingly, in some implementations, the indication transmitted from remote system 602 to mobile device 606 may further comprise an option that allows the operator of the device to confirm or deny whether they will participate in the joint transaction. In some implementations, remote system 602 may be configured to generate and send indications to mobile devices that match the requirements of the joint transaction (e.g., user requirements and/or authorization requirements) until at least one confirmation is received.

In some implementations, remote system 602 is further configured to generate additional notifications to transmit to the requesting mobile device 604 to keep the user of device 604 apprised of the status of the joint transaction. For example, if a qualifying mobile device accepts or denies participating in the joint transaction, remote system 602 may be configured to generate a corresponding notification for transmission and display at mobile device 604.

In some implementations, a history of joint transaction requests may also be stored at database 610. Such history may include identifiers for each mobile device that initiated a joint transaction, was invited to participate in a joint transaction, accepted the invitation to participate, denied the invitation to participate, and/or successfully authorized and completed the joint transaction.

Such stored information may then be used multiple ways. For example, in some implementations, remote system 602 may utilize the stored historical information to identify mobile devices to invite to a joint transaction based on prior interactions with the requesting mobile device. In other words, if a particular requesting device has been denied by a particular invited device, matching the two devices for future invitations may be negatively weighted by remote system 602.

The stored information may also be utilized by providers of the product or service associated with the authorized transaction element to ascertain helpful business information. For example, a business that provides a discount when two users are simultaneously in a store may access some or all of the stored information about the joint transaction in order to derive helpful information about the participants, the effectiveness of the discount, or other information.

As illustrated in FIG. 7, a modified implementation of a joint transaction system is illustrated. Joint transaction system 700 includes remote system 702 connected to database 710 that includes data 712. As described previously in conjunction with FIG. 6, remote system 702 may be a distributed computing system comprising a combination of physical and virtual hardware and may be located in multiple locations that are connected through any suitable means. Further, database 710 and data 712 may comprise multiple databases, datasets, and data architectures, and may also include both physical and virtual/logical storage.

In one implementation, dataset 712 includes identities of remote systems associated with and received from each of the first mobile device or the second mobile device. Further, the data set may include one or more characteristics associated with each of the identities within the dataset.

Remote system 702 is also configured to receive communications from mobile computing devices over communications channels 720 and 722. It is appreciated that the illustrated communications channels may be the same channel but that the information transmitted over the channels can be understood and directed to the appropriate mobile device as necessary.

Joint transaction system 700 also facilitates communications channel 724 that is illustrated as connecting mobile device 704 with mobile device 706. In one implementation, communications channel 724 operates utilizing a communication protocol that is different from channels 720 and 722. In one implementation, communications channel 724 operates utilizing the BLUETOOTH protocol or other similar short-range wireless protocol (e.g., NFC) or device specific short-range transmission protocols (e.g., AirDrop, Bonjour, ZeroConf, etc.).

It is also appreciated that while remote system 702 may not be configured to directly intermediate communications over channel 724, remote system 702 is configured to cause the communication to occur through, for example, controlling a mobile application installed on registered mobile devices. For example, in one implementation, remote system 702 is configured to transmit a command over communication channel 720 to mobile device 704 with an instruction for mobile device 704 transmit a signal over channel 724 using BLUETOOTH.

Thus, it is appreciated that remote system 702 is configured to enable direct communication between two different mobile devices without directly facilitating the propagation of the transmission signal.

In one exemplary implementation, remote system 702 receives a request to initiate a joint transaction from mobile device 704. As discussed previously, this request may include various information including preferences of the user of mobile device 704 regarding requirements for fulfilling the need for a matched computer system to participate in the joint transaction.

Based on receiving the request from mobile device 704, remote system 702 identifies any authorization parameters that are associated with the transaction. For example, remote system 702 consults database 710 to identify any requirements that need to be met before a transaction element associated with the requested joint transaction can be authorized. In at least one implementation, the requirement includes at least a verification that at least two mobile devices associated with the joint transaction are within the same geofence. Additionally, in accordance with FIG. 7, the authorization parameters also include a requirement that the two devices are also within a threshold relative distance from each other.

It is appreciated that these two exemplary authorization parameters are similar but not necessarily the same. For example, a geofence may capture an entire city while the relative distance between the two devices may be just a few feet. As but one example, a business associated with the transaction element of the joint transaction may have multiple locations within a city where the transaction element is valid. However, to utilize the transaction element, all participants of the joint transaction must be together at the same location. To accomplish this, a first location protocol is utilized to establish that the first verification requirement has been met (e.g., using GPS), while a second location protocol is utilized to establish that the participant devices are together (e.g., using BLUETOOTH.)

According to the implementation of FIG. 7, and differing from that of FIG. 6, rather than remote system 702 directly identifying a second mobile device to participate in the joint transaction, remote system 702 is configured to utilize the original mobile device 704 to identify another participant.

Thus, as illustrated, as a result of receiving a request to initiate the joint transaction, remote system 702 causes mobile device 704 to wirelessly broadcast an identifier over communications channel 724. As has been discussed, in one implementation, the broadcast is accomplished utilizing BLUETOOTH transceiver hardware built into mobile device 704. One having ordinary skill in the art would understand that utilizing BLUETOOTH transmissions necessarily limits the effective transmission range to around 50 meters or less. As such, it is understood that this implementation is seeking to connect the requesting mobile device to another device that is already within close physical proximity.

It is also understood that in order to protect the privacy and preferences of users of the mobile devices, an immediate/automatic connection between the two devices is not necessarily established using BLUETOOTH alone. For example, in one implementation, other mobile devices that are close to mobile device 704 may be configured to receive the transmitted identifiers using a background process of the mobile application associated with the system. Remote system 702 may then be configured to receive communications from other properly configured mobile devices, such as mobile device 706, including an indication that the mobile device 706 has received the identifier broadcast from mobile device 704.

In one implementation, remote system 702 is then configured to identify characteristics associated with mobile device 706 and compare those against any preferences or requirements that were included within the initial request received from mobile device 704. In a case where mobile device 706 satisfies those parameters (e.g., user 718 satisfies the preferences configured at mobile device 704 by user 716), remote system 702 is then configured to determine that the joint transaction should be authorized.

In response to this determination, remote system 702 then causes a notification to be transmitted to at least one of the mobile devices with an indication that the joint transaction is authorized.

As was previously discussed, system 700 may also be configured to repeat the matching algorithm to ensure that a suitable mobile device is paired with the requesting mobile device 704. This may include finding alternative mobile devices that better match the included parameters or finding an alternative mobile device that will affirmatively confirm acceptance of the joint transaction invitation.

The method 800 of FIG. 8 includes numerous acts according one implementation of the described invention. Method 800 begins with the act 802 of receiving a request, from a first user, to initiate a joint transaction. In one implementation, act 802 includes receiving, at the remote system, from a first mobile device, a request to initiate a joint transaction, the first mobile device being associated with a first user. For example, remote system 702 of FIG. 7 receives a request to join a joint transaction from mobile device 704. As previously described, this request may be received over a communications channel such as communications channel 720.

Act 804 includes identifying one or more authorization parameters associated with the joint transaction. In one implementation, act 804 includes identifying at the remote system, and based upon receiving the request, one or more authorization parameters associated with the joint transaction. Further, at least one of the one or more authorization parameters requires that an additional mobile device be identified. For example, remote system 702 may query data base 710, including dataset 712, to identify information relating to the requested joint transaction. This information may include one or more authorization parameters as previously described (e.g., number of required parties, location requirements, etc.)

It is also appreciated that the authorization parameters may also include user preferences identified by the user of the requesting mobile device. For example, the user of mobile device may configure preferences within user data 708 that are shared or accessible to remote system 702. These preferences may be configured to help remote system 702 to identify other parties that should be considered for joining the requested joint transaction. In one implementation, the set of preferences comprises an age, age range, gender, common interest, physical proximity threshold, or a group identifier. It is appreciated that other user preferences may also be included within user data 708 and relied on by remote system 702 for formulating a match

Act 806 then includes causing the requesting mobile device to wirelessly transmit, within a local area, an identifier that uniquely identifies the mobile device. For example, remote system 702 may cause mobile device 704 (e.g., through a mobile application installed on mobile device 704), to activate physical hardware within mobile device 704 to transmit a wireless signal. As has been described, in one implementation, this transmission conforms to a BLUETOOTH protocol. It is appreciated that the transmitted identifier may take many forms. It may be associated with a registered user account (e.g., a user name), a physical component of the mobile device (e.g., a MAC address), or a randomly assigned identifier, among other things. This broadcast may occur over a communications channel such as communications channel 724.

In act 808, a request is received from a different mobile device to join the joint transaction. In one implementation, act 808 includes receiving, at the remote system, from a second mobile device, a request to join the joint transaction. Further, the request to join the joint transaction includes at least the identifier wirelessly transmitted by the first mobile device. For example, mobile device 706 may be in proximity to mobile device 704 such that mobile device 706 is within range of the wireless transmission broadcast by mobile device 704 as described in act 806. Based on receiving the wireless request, the mobile device 706 may then transmit a request to join the joint transaction to remote system 702 over a communication channel such as communications channel 722.

In another implementation, remote system 702 receives the request from mobile device 706 through mobile device 704. Depending on the implementation, this may be beneficial to limit the number of sessions and connections that are needed between system 702 and participating mobile devices. In such an implementation, mobile device 706 may broadcast, perhaps again over communications channel 724, a wireless signal back to mobile device 704 indicating the request to join. Mobile device 706 may then pass that request back to remote system 702.

In yet another implementation, mobile device 704 may receive the request to join directly from mobile device 706 and perform some level of processing on the request prior to passing the request to remote system 702. For example, mobile device 704 may apply some filtering to ensure the request satisfies the user preferences, such as those stored in user data 708.

Notwithstanding the path taken for the request to return to remote system 702, act 810 includes determining that the request to join the joint transaction is authorized. For example, remote system 702 may compare information known about mobile device 706 such as information about user 718 stored in user data 714. In some implementations, user data 714 is shared with remote system 702 at registration and is then stored in dataset 712. In such implementations, remote system would then query database 710 to access the information. In another implementation, mobile device 706 may be configured to transmit some or all of user data 714 along with the request to join the joint transaction.

Remote system 702 may then compare the information associated with the request join the transaction to information known about the joint transaction. This information may include preferences included by the initial requester of the joint transaction (e.g., user 716), and/or information about the joint transaction itself such as authorization parameters required by a provider of a transaction element associated with the joint transaction.

In one embodiment, the authorization parameters include a physical location parameter. In such an implementation, for the remote computing system to determine that the request to join the joint transaction is authorized it must be determined that both the first mobile device and the second mobile device are located within a predefined geofence and are within predefined threshold distance from each other. For example, as described in FIGS. 5A through 5C, remote system 702 may require that both mobile devices be in the same physical location prior to authorizing the joint transaction.

In other implementations, remote system 702 may authorize a transaction but refrain from fully activating the associated transaction element unless and until all authorizations parameters have been met.

Act 812 then includes causing a notification to be generated on at least one of the mobile devices participating in the joint transaction. In one implementation this includes at least indicating that the joint transaction has been authorized an activated. As previously described, in some implementations, there may be a structural difference between an “authorized” transaction and an “activated” transaction. In one implementation, a joint transaction is authorized upon verifying that the participants of the joint transaction are eligible to receive the transaction element associated with the joint transaction. However, remote system 702 may refrain from fully activating a transaction element associated with a joint transaction until the eligible participants have also fully satisfied the authorization parameters of the joint transaction.

Depending on the implementation, this notification may take the form of a push notification, an in-app notification, an SMS message, or other suitable means.

In one implementation, an authorized and activated transaction element may be either deactivated or deauthorized if a condition relating to one or more of the participants changes. For example, if physical proximity is an authorization parameter, a joint transaction may be activated when two participants are close to each other. However, for various reasons, the parties may physically separate prior to utilizing the transaction element. In such instances, remote system 702 may be configured to deactivate the transaction element.

In another implementation, a characteristic of the participants themselves may change. For example, it may be determined, after initial authorization, that one of the participants no longer meets the user preferences defined in user data 708 or 714. In such an implementation, the transaction element may be deauthorized altogether.

Accordingly, one of ordinary skill in the art having read the present specification and claims will appreciate that implementations of the present invention solve a number of problems with prior social applications. These solutions are found at least in part through computerized systems, and applications as described herein, such as a system employing an application server, local installations (or instances of a remote location) of a mobile application, and a third-party location operator that agrees to form part of a transaction.

Although the subject matter has been described in language specific to structural features, modules, and/or methodological acts, it is to be understood that the subject matter defined in the appended claims is not necessarily limited to the described features, modules, or acts described above, or the order of the acts described above. Rather, the described features, modules, and acts are disclosed as example forms of implementing the claims.

Embodiments of the present invention may comprise or utilize a special-purpose or general-purpose computer system that includes, in its most basic configuration, computer hardware 900, such as, for example, one or more processors 902 and system memory 904 which may include both volatile and non-volatile memory.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer system 900 may also include physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Computer system 900 may also include transmission media including a network 910 and/or data links 912 which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection 908 (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. A method for enabling a joint transaction between two computing systems, the method comprising:
receiving from a first mobile device, a request to initiate a joint transaction, the first mobile computing system being associated with a first user;
based upon receiving the request, identifying one or more authorization parameters associated with the joint transaction;
generating a first token and transmitting the first token to the first mobile computing system;
transmitting a notification to a second mobile device, the notification comprising at least:
an indication, presented at a user interface of the second mobile computing device, comprising at least one of the one or more authorization parameters associated with the joint transaction and the identity of the first user; and
a second token;
receiving an indication from each of the first mobile computing system and the second mobile computing system, each indication comprising at least:
one physical parameter of the respective mobile computing system; and
the token transmitted to the respective mobile computing system;
determining, based on the received indications and the first token and the second token, that the first mobile computing systems and the second mobile computing system have simultaneously satisfied the one or more authorization parameters;
activating a transaction element; and
transmitting the transaction element to at least one of the first mobile computing system or the second mobile computing system.

2. The method of claim 1 further comprising:
querying a first data set associated with the first mobile computing system, the first data set stored remotely from the first mobile computing system.

3. The method of claim 2, further comprising:
determining an identity of a second mobile computing device based upon the first data set and one or more predetermined preferences configurable by the first user at the first mobile computing device, wherein transmitting the notification to the second mobile computing system comprises transmitting the notification based upon the determined identity.

4. The method of claim 2, wherein the one or more authorization parameters comprises a physical location defined by a geofence.

5. The method of claim 2, wherein the transaction element is automatically transmitted to the first mobile computing system and the second mobile computing system when they are simultaneously satisfying at least one of the one or more authorization parameters.

6. The method of claim 5, wherein the transaction element is automatically transmitted in the form of a push notification.

7. The method of claim 5, wherein the transaction element is automatically transmitted in the form of an app notification.

8. The method of claim 3, wherein the one or more predetermined preferences comprises one or more of an age, gender, relationship grouping, proximity, or name.

9. The method of claim 3, wherein the request to initiate a joint transaction includes a unique identifier associated with either or both of the first mobile computing device and the first user.

10. The method of claim 9, wherein the first data set is identified at least in part based on the unique identifier.

11. The method of claim 3, wherein first data set comprises at least a contacts directory for the first user received from the first mobile computing device and the identity of the second mobile computing device matches at least one entry in the first data set.

12. A computer system for authorizing a joint transaction, the computer system comprising:
one or more processors;
one or more computer readable hardware storage media comprising computer executable instructions configured to execute at the one or more processors, wherein executing the computer executable instructions at the one or more processors causes the computer system to at least:
receive, from a first mobile device, a request to initiate a multi-entity transaction, the first remote system being associated with a first user that is registered at the computer system;
based upon receiving the request, identify one or more authorization parameters associated with the joint transaction;
generate a first token and transmitting the first transaction token to the first mobile device;
transmit a notification to a second mobile device, the notification comprising at least:
an indication, presented at a user interface of the second mobile device, comprising at least one of the one or more authorization parameters associated with the joint transaction and the identity of the first user, and
a second token;
receive an indication from each of the first mobile device and the second mobile device, each indication comprising at least:
one physical parameter of the respective mobile device; and
the token transmitted to the respective mobile device;
determine, based on the received indications and tokens, that the first mobile device and the second mobile device are simultaneously satisfying the one or more authorization parameters;
activate the joint transaction element; and
transmit the joint transaction element to at least one of the first mobile device or the second mobile device.

13. The system of claim 12, wherein the executable code further comprises executable instructions that cause the computer system to:
identify that at least one of the first mobile device or the second mobile device are no longer satisfying the one or more authorization parameters, and as a result, at least temporarily deactivate the joint transaction element.

14. The system of claim 12, further comprising:
a dataset comprising identities of remote systems associated with and received from each of the first mobile device or the second mobile device, wherein the data set comprises one or more characteristics associated with each of the identities within the dataset.

15. The system of claim 14, wherein the request further includes at least one of the one or more characteristics that matches a characteristic stored in the data set for the second remote system.

16. A method, operated at a remote system, for dynamically enabling a joint transaction between two computing systems, the system comprising:
receiving, at the remote system, from a first mobile device, a request to initiate a joint transaction, the first mobile device being associated with a first user;
based upon receiving the request, identifying, at the remote system, one or more authorization parameters associated with the joint transaction, wherein at least one of the one or more authorization parameters requires that an additional mobile device be identified;
causing, by the remote system, the first mobile device to wirelessly transmit an identifier within a defined local area, wherein the identifier uniquely identifies the first mobile device at the remote system;
receiving, at the remote system, from a second mobile device, a request to join the joint transaction, the request to join the joint transaction including at least the identifier wirelessly transmitted by the first mobile device;
determining, at the remote system, that the request to join the joint transaction is authorized; and
causing, by the remote system, a notification to be generated on at least one of the first mobile device or the second mobile device, the notification at least indicating that the joint transaction has been authorized and activated.

17. The method of claim 16, wherein the one or more authorization parameters further comprise a set of preferences configured at the first mobile device identifying preferred characteristics of a user of the additional computing system.

18. The method of claim 17, wherein determining that the request to join the joint transaction is authorized further comprises determining that the user of the second mobile device meets the requirements of at least one of the set of preferences configured at the first mobile device.

19. The method of claim 17, wherein the set of preferences comprises one or more of an age range, gender, common interest, physical proximity threshold, or group identifier.

20. The method of claim 16, wherein the one or more authorization parameters further comprises a physical location parameter, wherein determining, at the remote computing system, that the request to join the joint transaction is authorized includes determining that both the first mobile device and the second mobile device are located within a predefined geofence and are within predefined threshold distance from each other.
